(19) United States
(12) Patent Application Publication
(10) Pub. No.: US 2015/0026659 A1
(43) Pub. Date: Jan. 22, 2015

(54) SYSTEM AND METHOD FOR PROGRAMMING AND CONTROLLING INSTRUMENTS

(71) Applicant: FRANK DING, CHARLOTTE, NC (US)

(72) Inventor: FRANK DING, CHARLOTTE, NC (US)

(21) Appl. No.: 14/303,183

(22) Filed: Jun. 12, 2014

Related U.S. Application Data
(60) Provisional application No. 61/856,630, filed on Jul. 19, 2013.

(51) Int. Cl. G06F 9/44

(52) U.S. Cl. CPC G06F 8/34
USPC 717/109

(57) ABSTRACT

A system comprising one or more program control processors, and a non-volatile computer readable medium storing a computer program instructions operable to cause the one or more program control processors to perform operations is disclosed. The operations include receiving an instruction code, executing the instruction code, and synchronizing one or more pre-defined real-time variables (PRVs) with one or more of an industrial hardware peripheral.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE INVENTION

The present invention relates to hardware systems. More specifically, the present invention relates to the programming and control of programmable hardware systems.

Industrial instruments are typically made with a microcontroller or computers that executes specific program previously burnt on the built-in non-volatile memory. Such a microcontroller collects data from its adjunct input peripherals, such as analog and/or digital input signals, executes certain program logic, and export data onto relevant output peripherals, such as analog output and/or digital outputs. As the simplest example, a digital temperature controller is made with a microcontroller, a temperature sensor which provides analog voltage signals, and a controlled power output which controls a heating element. The program burnt in the microcontroller collects temperature data from the analog input channels, and calculates required power output data based on the temperature value, and output the data onto the heating power, thus controls the target temperature to a specific setpoint value.

Traditionally, a program is developed on a desktop computer using a specifically development software. A program language, such as C, is used to develop the program code. The program code is then translated into binary code specific to the microcontroller, which is then burnt into the microcontroller's non-volatile memory, from which it is executed. The program is emulated and debugged via certain debug interface, through which emulation information is transferred to the desktop computer.

This process requires that the user be heavily trained, and fully understand the hardware structure as well as the programming language of the specific microcontroller. Furthermore, the program that the user developed is not readily transferable to another platform. In other words, if the hardware is modified (e.g., a different microcontroller is used), then the program has to be rewritten to fit that specific microcontroller.

Therefore, there exists a need for an improved method for programming and controlling a hardware system. This and other needs are addressed by one or more aspects of the present invention.

### SUMMARY OF THE INVENTION

The present invention includes many aspects and features. Moreover, while many aspects and features relate to, and are described in, the present invention is not limited to use only in this context, as will become apparent from the following summaries and detailed descriptions of aspects, features, and one or more embodiments of the present invention. Accordingly, one aspect of the present invention relates to a system comprising one or more program control processors, and a non-volatile computer readable medium storing a computer program instructions operable to cause the one or more program control processors to perform operations. The operations include receiving an instruction code, executing the instruction code, and synchronizing one or more pre-defined real-time variables (PRVs) with one or more of an industrial hardware peripheral and a graphical user interface (GUI) element.

In a feature of this aspect, wherein the one or more program control processors perform operations further comprising receiving program code input by a user, and compiling the program code to generate the instruction code.

In another feature of this aspect, further comprising one or more industrial hardware controller processors, and a non-volatile computer readable medium storing a computer program instructions operable to cause the one or more industrial hardware controller processors to perform operations.

In another feature of this aspect, wherein the one or more program control processors perform operations further comprising forwarding the received instruction code to the one or more industrial hardware controller processors, wherein at least one of the one or more PRVs are synchronized to one or more industrial hardware peripheral.

In another feature of this aspect, wherein the one or more industrial hardware controller processors perform operations comprising receiving the instruction code; executing the instruction code, and controlling the one or more industrial hardware peripheral based on the executed instruction code, wherein one or more PRVs included in the executed instruction code are synchronized with a respective industrial hardware peripheral signal.

In another feature of this aspect, comprising one or more industrial hardware peripherals, wherein the executed instruction code controls the operation of the one or more industrial hardware peripherals, and wherein the one or more PRVs include one or more of an analog input, a digital input, an analog output and a digital output.

In another feature of this aspect, wherein one of the one or more digital input is synchronized with one of the industrial hardware peripherals that provides the one or more program control processors.

In another feature of this aspect, wherein the one or more program control processors perform operations further comprising resetting the PRVs associated with each of the one or more industrial hardware peripherals when the instruction code is initiated.

In addition to the aforementioned aspects and features of the present invention, it should be noted that the present invention further encompasses the various possible combinations and subcombinations of such aspects and features. Thus, for example, any aspect may be combined with an aforementioned feature in accordance with the present invention without requiring any other aspect or feature.

### BRIEF DESCRIPTION OF THE DRAWINGS

One or more preferred embodiments of the present invention now will be described in detail with reference to the accompanying drawings, wherein the same elements are referred to with the same reference numerals, and wherein,

FIG. 1 is an example illustration of a block diagram of an implementation of a disclosed instrument system controller and hardware system in accordance with the present invention;

FIG. 2 is an example illustration of a block diagram of an implementation of an instrument control system in program mode in accordance with the present invention;

FIG. 3 is an example illustration of a block diagram of an implementation of an hardware system operating in mobile mode in accordance with the present invention;

FIG. 4 is an example illustration of an implementation of a mobile temperature controlling hardware unit;

FIG. 5 is an example illustration of an implementation of the instrument controller operating in supervisory control mode;

FIG. 6 is an example flow diagram of an implementation of the instrument control system in program mode;

FIG. 7 is an example flow diagram of an implementation of the mobile hardware system of FIG. 3; and

FIG. 8 is an example illustration of an user interface including GUI elements when coupled to the instrument system controller illustrated in FIG. 2.

### DETAILED DESCRIPTION

Referring now to the drawings, one or more preferred embodiments of the present invention are next described. The following description of one or more preferred embodiments is merely exemplary in nature and is in no way intended to limit the invention, its implementations, or uses.

As a preliminary matter, it will readily be understood by one having ordinary skill in the relevant art (“Ordinary Artisan”) that the present invention has broad utility and application. As should be understood, any embodiment may incorporate only one or a plurality of the above-disclosed aspects of the invention and may further incorporate only one or a plurality of the above-disclosed features. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. As should be understood, any embodiment may incorporate only one or a plurality of the above-disclosed aspects of the invention and may further incorporate only one or a plurality of the above-disclosed features. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof It is not intended that the scope of patent protection afforded the present invention be defined by reading into any claim a limitation found herein that does not explicitly appear in the claim itself

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

A method for programming and operating industrial instruments is disclosed. The disclosed system and method allows the hardware system to execute a series of instructions using a set of instructions that is stored in the hardware system and executed by a control processor included in the hardware system, thereby allowing the hardware system to be independent of a separate computer.

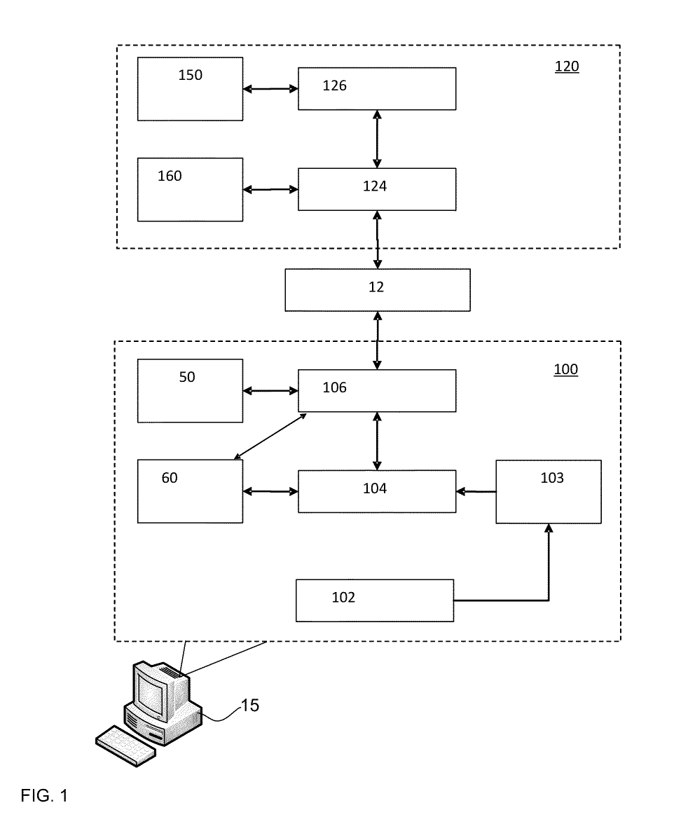

An example of a suitable computing device operable in accordance with an implementation of the disclosed system and method is illustrated in FIG. 1.

Program Mode

An example block diagram of a suitable instrument system controller (computing device) operable to program a set of instructions for use by a hardware system or supervise the operation of an hardware system before a set of instructions are stored in the hardware system, in accordance with an implementation, is illustrated in FIG. 1. It should be noted that the various functional blocks shown in FIG. 1 may include hardware elements, software elements (including computer code or instructions stored on a non-volatile machine-readable medium) or a combination of both hardware and software elements. The instrument system controller 100 may be implemented in different forms. For example, the instrument system controller 100 may be implemented as a desktop computer, laptop, workstation and other appropriate computers.

The instrument system controller 100 includes a program compiler 102, instruction code memory 103 and a program control processor 104. The controller memory 103 stores program code for a program that is designed to operate an hardware system. The program code is preferably produced in a designated compiling software environment (an integrated development environment (IDE)) that runs from a computing device 15. In this instance, the program control processor 104 is the same as the central processing unit (CPU) of the computer 15. In an implementation, the processor can be a separate instrument having the same functionalities as described above, and which communicates with the computer 15. In accordance with an implementation of the disclosed system and method, the program code may be generated in text or graphical format.

Once the program code has been created, the program compiler 102 converts the text-based or graphic based program code into a set of executable instruction codes. The set of instruction codes generated by the controller compiler 102 are then forwarded to the instruction code memory 103. The instruction code memory 103, coupled to the controller compiler 102 and the program control processor 104, stores the set of instruction codes from the controller compiler 102 for execution by the program control processor 104.

The program control processor 104 sequentially reads and executes the set of instruction code from the instruction code memory 103. Based on the instruction that is executed, an instruction signal is forwarded to one or more controller driver(s) 106 that performs a certain predefined function. The predefined function may include the operation of, or management of data communication to/from, a hardware/software peripheral 50, for example a set of graphical user interface (GUI) elements. The predefined function may also synchronize the values from a hardware peripheral channel with a variable declared in the specific location of the RAM, i.e., a pre-defined real-time variable (PRV) 60, to be disclosed below.

It is preferable that the one or more controller driver(s) 106 is a software package that has a set of function blocks that do specific hardware-related operations. In other implementations, the one or more controller drivers 106 may be a separate instrument system including one or more processors that execute similar functionalities as the software package. The separate hardware system communicates back and forth with the control processor 104.

As the instructions are executed by the program control processor 104, a driver may forward the executed instruction to a hardware system 120 coupled to the instrument system controller 100 through a communication port 12. An example block diagram of an hardware system 120 is also illustrated in FIG. 1. An example hardware system 120 may be a temperature controlling unit, an automobile braking system controlling unit, or a generic all-purpose controller unit. The hardware system 120 includes an instrument control processor 124, a set of variables including predefined realtime variables 160, and one or more drivers 126. Similar to the program control processor 104 disclosed above, the instrument control processor 124 executes a set of instruction code that is received through the communication port 12, or a set of instruction code that is pre-loaded and stored in a non-volatile memory (not shown in this example) included in the hardware system 120, to be disclosed below. The instrument control processor 124 communicates with the one or more drivers 126 when called for in the instruction, or communicates directly with a peripheral 150. As disclosed above, the hardware drivers 126 may be a software package stored in the hardware system 120 or a separate hardware controller.

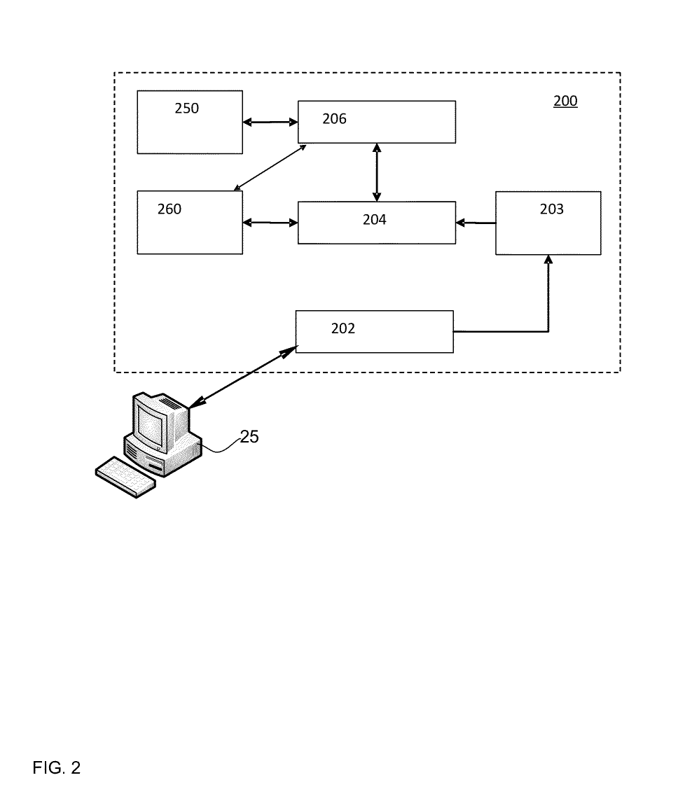

In accordance with the disclosed instrument control system, an implementation of the instrument control system 100 in program (development) mode is illustrated in FIG. 2. As used herein, program mode refers to the generation of a control program that is be used for the control of an hardware system, similar to the instrument control system 100 illustrated in FIG. 1. A user/programmer writes a program script in an editor interface 25. Once the user has completed writing the program, the program compiler 101 translates the user's program code into a set of instruction codes.

In the disclosed implementation, a programming language is used that allows a user to create a program to operate an instrument system. The programming language for purposes of this disclosure is called z language, which may be compiled into a set of instruction codes called “z code”. An example list of the z code commands and their respective meanings is provided in Table I. It must be noted that this is not a complete list of the z code commands, and the list has been provided for exemplary purposes only.

TABLE I
List of Instruction Code Commands

| Value | Command Name | Command Description |
|---|---|---|
| 0 | CMD_NOPE | Do nothing |
| 1 | CMD_BEGIN | Program Begins |
| 2 | CMD_END | Program Ends |
| 3 | CMD_OPEN | Open a file |
| 4 | CMD_SLEEP | Sleep |
| 5 | CMD_WAKE_UP | Wake up |
| 6 | CMD_WAKE_UP_ON | Wake up on certain |
| | | condition |

In such a language environment, a set of pre-defined real-time variables (PRVs) are provided that are synchronized with respective hardware peripherals when a z-program is executed, to be disclosed below. Example PRVs may include certain analog inputs, analog outputs, digital inputs and/or digital outputs.

The set of instructions codes, e.g., z codes, are then forwarded to the instruction code memory 203. The instruction code memory 203 stores the set of instructions from the program compiler for execution by the control processor 204.

When the user runs this set of instructions, the control processor 204 sequentially reads the instruction codes (starting from an entry point) from the instruction code memory 203, and executes each instruction code. If the instruction code is related to a hardware peripheral 250 operation, the control processor 204 calls the driver 206 which controls the respective hardware peripherals. In program mode, the driver 206 may also control one or more GUI elements 250.

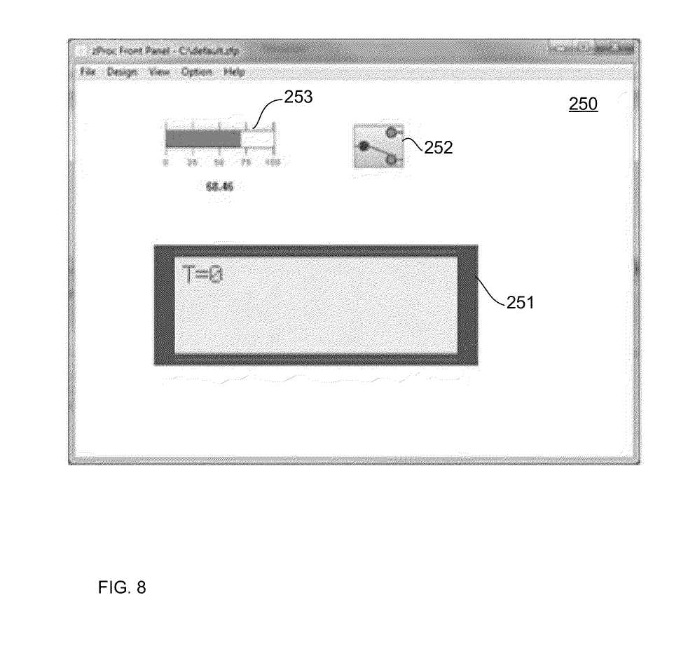

The GUI elements 250 are visual representations that represent the hardware peripherals 250 that the user's program is designed to control. An example illustration of a user interface 250 including the GUI elements 251, 252 and 253 is shown FIG. 8. As illustrated, the GUI element 251 simulates an LCD display, element 252 simulates a thermometer and element 253 simulates a relay in a temperature controlling hardware unit, for example.

Referring back to FIG. 2, in accordance with the disclosed implementation, the one or more GUI elements 250 simulate the one or more hardware peripherals that are controlled in the industrial environment, such that both the hardware peripherals and the GUI elements operate in the same manner according to the executed instruction code.

As an example, if an instruction code for display is executed by the control processor 204, the control processor 204 calls driver 206 to read all successive codes and put all code parameters together to form a text string. The control processor then instructs the driver 206 to send the string to the GUI element 250, e.g., a LCD display 251 (illustrated in FIG. 8).

Referring to FIG. 1, if a hardware peripheral 120 is connected to the instrument control system 100 via a communication port 12, the driver 126 sends the display command to the hardware peripheral 120, as well as the text string. The hardware peripheral's driver 126 receives the command and the text string, and displays the string onto the hardware LCD display 125 included in the hardware peripheral 120.

Moreover, a GUI element 250 can be designed such that it synchronizes with a PRV 260. In such cases, the status or value of the GUI element 250 is synchronized with the PRV 260 as well as the hardware peripheral for which the PRV synchronizes. For example, item 253, illustrated in FIG. 8, can be configured to be synchronized to PRV A[0], which synchronizes to a temperature sensor. At run time, both the value of A[0] in memory and the meter 253 on the GUI are synchronized with the temperature value measure at the temperature sensor on a hardware system (not shown). Similarly, the content of the LCD element 251 can be synchronized to a string variable PRV, which synchronizes with a hardware LCD built on the hardware system (not shown). In all such cases, the GUI elements 250 synchronize with hardware peripherals through certain PRVs. The synchronizations are performed by the drivers 206 and are independent of the instruction code in 203.

The synchronization between a predefined real-time variable and the hardware or GUI elements depends on whether the predefined real-time variable is an input or an output. For an input PRV, the value of the hardware peripheral channel, is assigned to the PRV as well as any GUI elements associated to the PRV. For example, in synchronizing a PRV connected to a temperature sensor, the value on the temperature sensor is assigned to the PRV as well as any GUI elements associated to the PRV.

For an output PRV, the change of the PRV value in the program will cause the respective hardware peripheral channel to update to the PRV value. For example, if the value of the PRV that connects to a power relay changes from 0 to 1, the synchronization process will change the status of the power relay from off to on.

While the instrument control system 200 is operating in program development mode, the user may adjust the program codes and clear any bugs until a successful control program has been developed. Using the disclosed instrument control system, the user has the ability to simulate the operation of the hardware system and view how the system responds to the program being developed.

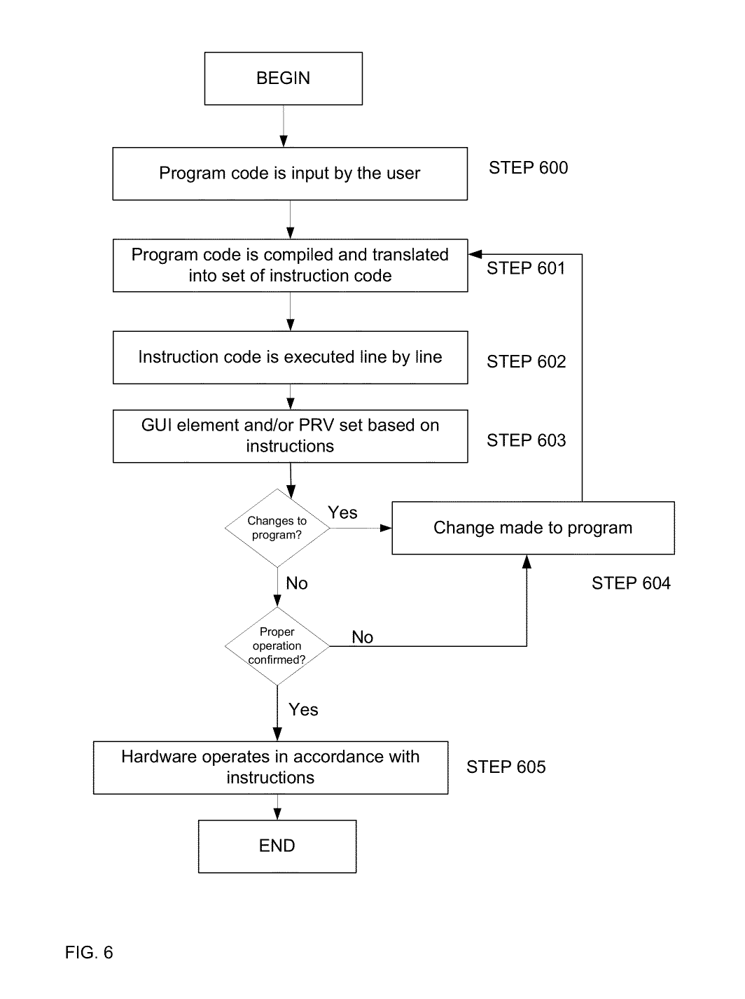

An example flow diagram of the implementation of the instrument control system in program mode is illustrated in FIG. 6. A user/programmer inputs program code that will be used by a hardware system. STEP 600. The program code is compiled and translated into a set of instruction code. STEP 601. The set of instructions code is then executed line by line. STEP 602, and the GUI element used to represent the hardware system and/or a PRV are set in accordance with the executed instruction. STEP 603.

As the instructions are being executed, the user my make changes to the program to ensure proper operation of the hardware system. STEP 604. Once the user confirms that the program is operating properly, the instrument control system is taken out of program mode. STEP 605.

Mobile Mode

Once the control program has been developed and meets the requirements of the user, the user may send the set of instruction code to the hardware peripheral via the communication port, and store the set of instruction code into the hardware's non-volatile memory, allowing the hardware to operate in mobile mode, an operation mode where the instrument control system 100, computer 15, and communication port 12 are detached from the hardware system and no longer needed.

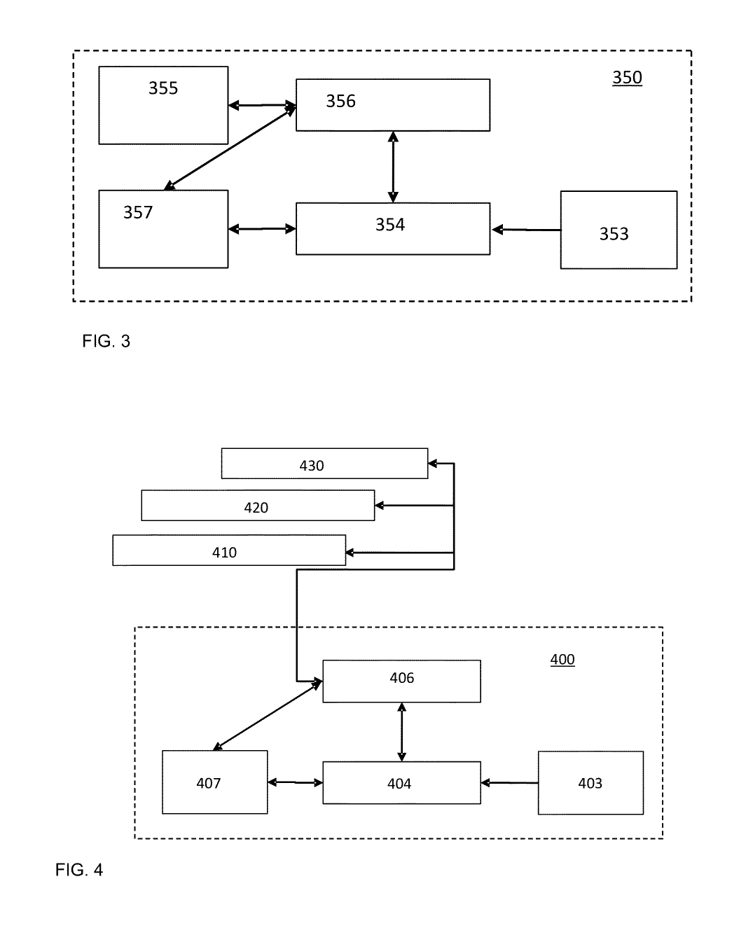

An example block diagram of an hardware system operating in mobile mode is illustrated in FIG. 3. As illustrated in this example, the hardware system 350 includes an hardware control processor 354, an instruction code memory 353, one or more hardware drivers 356, a set of PRVs 357, and hardware elements 355. The hardware memory 353 stores a set of instruction code. The set of instruction is burned into the hardware memory after the instrument control system generates the set of instruction code. When the hardware system 350 is reset or powered on, the hardware control processor 354 sequentially reads the instruction code from the hardware memory 353 and executes the instruction code in the same manner disclosed above. The hardware control processor 354 sends commands to the one or more drivers 356 based on the executed instruction code, wherein the one or more drivers 356 operate as disclosed above. Since there is no external computer connected to the instrument hardware, a hardware system is mobile.

An example block diagram of a mobile temperature controlling hardware unit, in accordance with the disclosed implementation, is illustrated in FIG. 4. The illustrated example is an on/off temperature control instrument 400 that turns a heater on when the environment temperature is below a certain limit, e.g., 70° F., and turns the heater off when the temperature rises above a certain limit, e.g., 72 ° F.

The hardware unit 400 includes an instrument control processor 404, one or more drivers 406 that communicate with at least one analog input and one digital output channels, an instrument code memory 403, for storing the set of instruction code, and a PRV element 405. A temperature sensor 420 is connected to an analog input channel of the hardware unit driver 406, which is synchronized as PRV A[0], i.e., an analog input. A relay switch 420 is coupled to a digital output channel of the hardware unit driver 406, which is synchronized as PRV d[0], i.e., a digital output. The PRV element 405 includes the values of A[0], d[0], wherein the instrument control processor 404 or driver 405 updates the values therein for execution of the set of instructions by the instrument control processor 404.

An example of a program that may be used in an implementation of the hardware control system may be written as For every 1 second:

If A[0]>72 then d[0] = 0
If A[0]<70 then d[0] = 1
Display “T={A[0]}”
Loop

In the above example program, the first and the last line defines an infinite loop so that the program code is executed every second. The program is designed such that the analog input A[0], i.e., the temperature value, from the temperature sensor 430 is checked by the instrument control processor 404. If the temperature is greater than 72 degrees, the heater switch is turned off, wherein the digital output d[0] is set to 0 by the instrument control processor 404 and forwarded to the heater power switch relay 420 in order to turn off the heater. If the temperature value A[0] is below 70 degrees, the instrument control processor sets the digital output d[0] to 1 in order to turn the heater power relay switch 420 off. The temperature LCD display 410 displays the temperature value A[0] when the 4^{th} line of the program is executed by the instrument control processor 404.

The example program as set forth above is compiled into a set of instruction code (as shown in Table 1) by the compiler included in an instrument system controller, exemplified in FIG. 1. The set of instruction code is stored in an instrument system controller memory or hardware memory 403, and then transferred via a communication port.

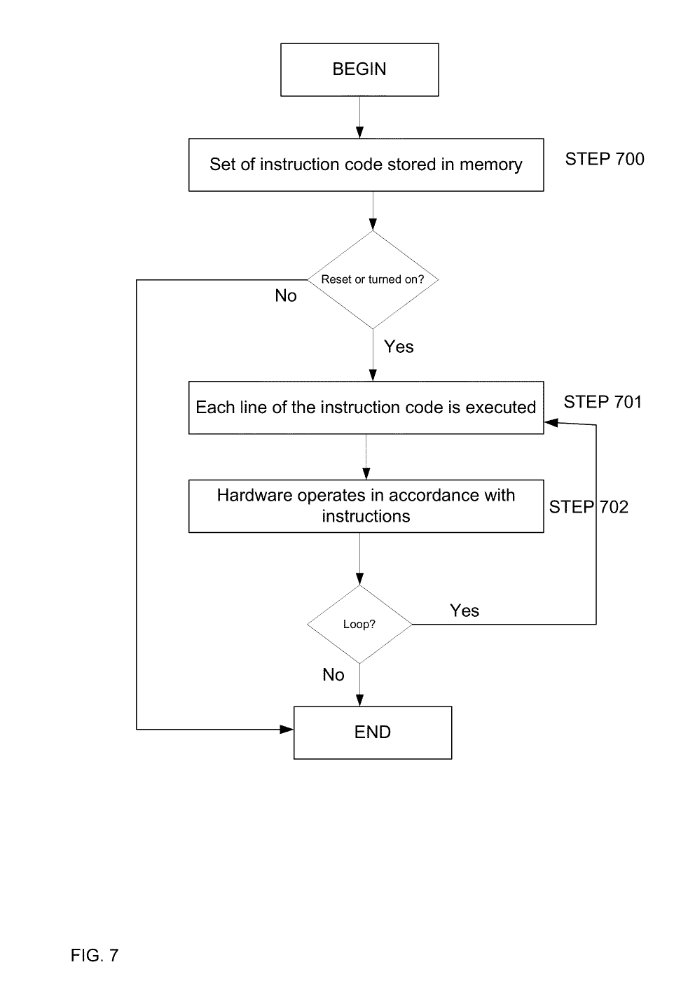

An example flow diagram of an implementation of a disclosed mobile hardware system is illustrated in FIG. 7. A set of instruction code is received and stored in the hardware system memory. STEP 700. When the hardware system is turned on or reset, each line of the instruction code is executed by the hardware system processor. STEP 701. In response to the instructions, the hardware operates in accordance with the instructions. STEP 702. The system continues to operate in this manner until the system is turned off

Supervisory Mode

In an implementation, the instrument system controller operates in supervisory control mode when coupled to an hardware system via a communication port. In supervisory mode, the instrument system controller may exchange data with the hardware system, and control the operation of the hardware system using a set of instruction code stored in the instrument system controller. In this mode, the program control processor opens a z-code file and executes the codes in the same manner as in program mode disclosed above, except that the user can no longer modify the code content.

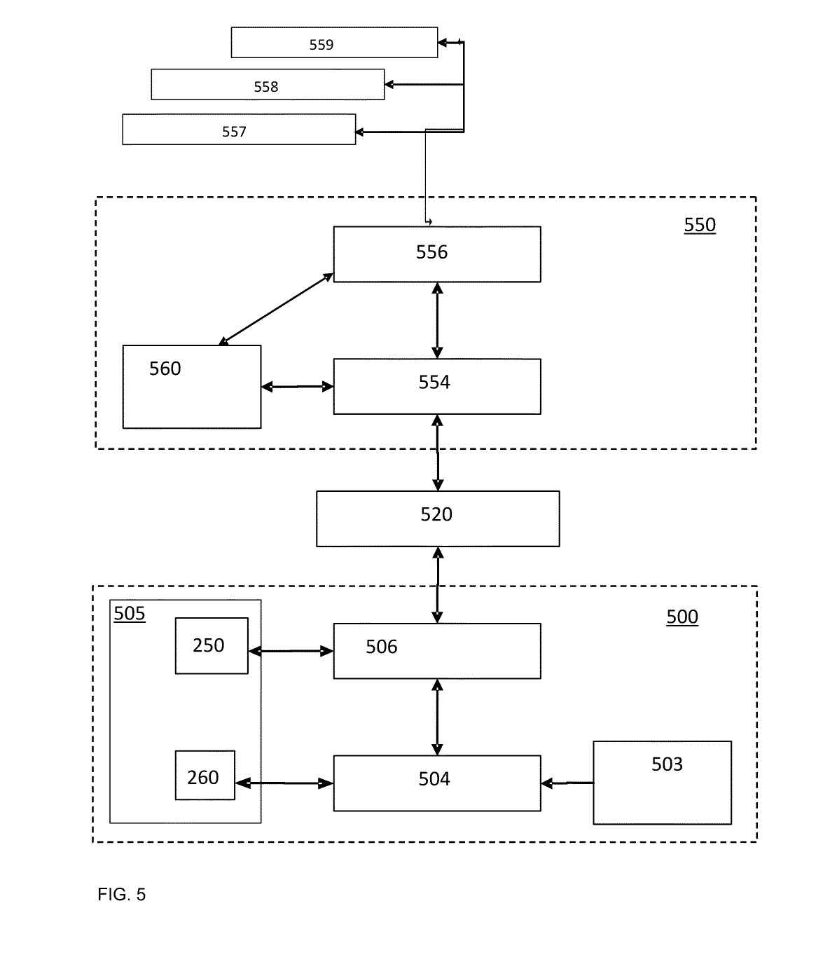

An example block diagram of this implementation is illustrated in FIG. 5. As illustrated, the instrument system controller 500 is similar to the instrument system controller 200 shown in FIG. 2. In the supervisory control mode, the instrument system controller 500 does not include the program compiler as included when operating in the program mode. The set of instruction code for the program that is running is stored in the instruction code memory 503.

The program control processor 504 sequentially reads the instructions from the instruction code memory 503 similar to the instrument control processor 304 illustrated in FIG. 4. The instrument system controller 500 includes PRV elements 260, coupled to the program control processor 504, and GUI elements 250 coupled to the driver 506. The PRV 260 values A[0] and d[0] disclosed above are synchronized with the PRV 560 values A[0] and d[0] of the hardware system 550, which is similar to the hardware unit 300 illustrated in FIG. 4.

In the supervisory mode example of FIG. 5, the program control processor 506 executes each line of the temperature control program set forth above that same as the instrument control processor 304 of FIG. 3. The driver 506 receives the instruction from the program control processor 506 and forwards the instruction to the instrument control processor 554 through communication port 520. The instrument control processor 554 executes the instruction as described above.

FIG. 8 illustrates the GUI element 250 for this temperature controlling example, where the thermometer 253 and UI LCD display 251 are synchronized with A[0], the temperature value, along with the temperature sensor 559, and the relay 252 is synchronized with d[0] along with the heating power switch relay 558.

Synchronization of the PRVs

In all three operation modes, namely the program mode, the mobile mode, and the supervisory mode, the PRVs are synchronized with respective hardware peripherals, as well as, certain UI elements by respective drivers. The synchronization does not require explicit user program intervention, i.e., the user does not need to write program code to instruct the driver to synchronize the PRVs.

As the name implies, the PRVs are defined (created, declared) by the compiling environment of the language before a new program is created. This is accomplished by declaring storage space in the computers RAM, and declaring names and optionally name scopes for these variables in the variable vector. For example, a vector of variable “A” is defined which is synchronized with a set of analog input channels in the hardware system. Similarly, a vector variable “a” can be defined which is synchronized with a set of analog output channels in the hardware system; a vector variable “d” can be defined which is synchronized with a set of digital output channels in the hardware system, etc.

It should be noted that the PRVs may be represented by a text symbol or graphical symbol in the user program.

A PRV has all the attributes of any other variables a programmer may declare. The difference is that the PRV values are automatically synchronized with the respective hardware channels. Synchronizing of the PRVs means that, at the program's run time, (a) for an input PRV (e.g., analog input “A”, digital input “D”), the value of the respective hardware channel is sampled, and assigned to the PRV; (b) for an output PRV (e.g., analog output “a”, digital output “d”), the value of the PRV is assigned to the respective hardware channel. For example, synchronizing A[5] means that the instrument system controller processor or hardware system processor will take sample values of the analog input channel #5 via an analog-digital converter (ADC), and assign the value to the PRV A[5]; if the voltage on channel 5 is 2.5 volt, then the value of A[5] is updated as 2.5. In some implementations, an optional calibration may be applied with which the value of voltage is converted to some other quantity such a temperature (in Fahrenheit). This calibration formula is typically assigned by the programmer via the software's user interface.

Synchronizing between the PRVs and hardware signals can be implemented in various modes. One is periodic synchronization mode. In this mode, the language's execution environment synchronizes the PRV values with their respective hardware signals in a periodic manner. For example, in one implementation, the execution environment synchronizes each of the PRVs every 10 milliseconds,i.e., for input signals, the processor takes the reading from the hardware signals and assigns the values to the PRVs; for output signals, it assigns the PRV values to the respective hardware signals.

One other synchronizing mode is instantaneous synchronizing mode. In this mode, the execution environment synchronizes a PRV only when this PRV is involved in a computing formula in the program. If the PRV links to an input hardware signal, the execution environment synchronizes it before any reading of the PRV; if the PRV links to an output hardware signal, the execution environment synchronizes it immediately after the PRV is assigned a new value.

The PRV synchronizing process can also be implemented by embedding the data synchronization code into the compiled executable code during the compilation process, i.e., a set of data synchronization code is embedded before any reading operation of an input PRV, while a set of data synchronization code is embedded after any writing operating to an output PRV.

At run time, PRVs can also be synchronized with any user interface elements. These user interface elements often are designed as graphical elements to visually represent the status of a hardware unit. For example, a numeric dial can be designed on a user interface to represent a pressure gauge, which is attached to a specific analog input. An execution environment can be designed such that when a PRV value is synchronized with the respective hardware signal, it is also synchronized with a respective element on the user interface such that the value of the hardware signal is shown on the user interface.

The components of the computing devices as illustrated in the FIGs., their connections and relationships and their functions are meant for exemplary purposes only, and are not meant to limit implementations of the disclosed inventions described and/or claimed in this disclosure.

A display device may be used to display images generated by the computing device 100, for example a graphical user interface (GUI). The display may be any type of display such as a cathode ray tube (CRT), a liquid crystal display (LCD), a light emitting diode (LED) display, or other suitable display. In certain implementations of the computing device, the display may include a touch-sensitive element, such as a touch screen.

The processor(s) may provide data processing capability to execute and support one or more operating systems, computer programs, user and application interfaces, software systems and applications, and any other functions of the computing device that may be stored in memory. The processor(s) may include one or more microprocessors, such as one or more “general-purpose” microprocessors, one or more special-purpose microprocessors and/or ASICS, for example.

The processor(s) may communicate with a user through an input interface and a display interface coupled to the display. The display interface may comprise appropriate circuitry for driving the display to present graphical and other information to a user. The input interface may receive commands from a user and convert them for submission to the processor(s).

The instructions or data to be processed by the processor(s) may be stored in a memory. The memory may be provided as a volatile memory, such as random access memory (RAM), and/or as a non-volatile memory, such as read-only memory (ROM). The memory may store a variety of information and may be used for various purposes. For example, the memory may store firmware executed by a processor (such as methods and systems for programming, supervising or operating a hardware system as discussed herein), other programs that enable various functions of the computing device, user interface functions, processor functions. The memory may also be another form of computer-readable medium.

The components may further include a non-volatile storage for persistent storage of data and/or instructions. The non-volatile storage may include flash memory, a hard drive, or any other optical, magnetic, and/or solid-state storage media. The non-volatile storage may be used to store data files, software, wireless connection information (e.g., information that may enable the computing device to establish a wireless connection, and any other suitable data). In addition, the non-volatile storage may also store code and/or data for implementing various functions of the computing device, such as application or program code, data associated with such applications or programs, operating system code, user configured preferences, as well as code for implementing methods and systems for programming, supervising and/or operating a hardware system as discussed herein. In implementation, the storage device may be or contain a computer-readable medium. A computer program product can be tangibly embodied in an information carrier. The computer program products may also contain instructions that, when executed, perform one or more methods, such as those described above. The information carrier is a computer- or machine-readable medium, such as the memory, the storage device, memory on processor, or a propagated signal.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

The disclosed system and methods are preferably implemented by software, hardware, or a combination of hardware and software. The disclosed implementations can include implementation in one or more computer programs that are executable and/or interpretable on a programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in an appropriate programming language. As used herein, the terms “machine-readable medium” “computer-readable medium” refers to any computer program product, apparatus and/or device (e.g., magnetic discs, optical disks, memory) used to provide machine instruction and/or data to a programmable processor.

Based on the foregoing description, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention. Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof

What is claimed is:

1. A system comprising:
one or more program control processors; and
a non-volatile computer readable medium storing a computer program instructions operable to cause the one or more program control processors to perform operations comprising:
synchronizing one or more program control pre-defined real-time variables (PRVs) with a respective one of a one or more of an industrial hardware peripheral and a graphical user interface (GUI) element
receiving an instruction code; and
executing the instruction code.

2. The system of claim 1, wherein at least one of the one or more program control PRVs is a program control input PRV, such that a value of the at least one program control input PRV is modified by the respective one of the one or more industrial hardware peripheral and GUI synchronized with the program control input PRV and accessed by the instruction code.

3. The system of claim 1, wherein at least one of the one or more program control PRVs is a program control output PRV, such that when a value of the program control output PRV is modified by the instruction code, the respective one of the one or more industrial hardware peripheral and GUI, synchronized with the program control output PRV, is automatically updated to the value of the said program control output PRV.

4. The system of claim 3, wherein the one or more program control processors perform operations further comprising:
receiving a user input program, wherein at least one or more PRVs are accessed by the program and synchronized with respective industrial hardware peripheral when the program is executed; and
compiling the user input program into a set of instruction code.

5. The system of claim 3 further comprising:
one or more industrial hardware controller processors; and
a non-volatile computer readable medium storing a computer program instructions operable to cause the one or more industrial hardware controller processors to perform operations comprising
modifying an hardware output PRV to be equal to the program control output PRV when the value of the program control output PRV is modified by the instruction code.

6. The system of claim 2 further comprising:
one or more industrial hardware controller processors; and
a non-volatile computer readable medium storing a computer program instructions operable to cause the one or more industrial hardware controller processors to perform operations comprising
modifying a value of an hardware input PRV by the respective one of the one or more industrial hardware peripheral and GUI synchronized with the program control input PRV.

7. The system of claim 1, wherein the program control PRVs are synchronized at a predetermined interval.

8. The system of claim 1, wherein the program control PRVs are synchronized as needed, such that a program control input PRV is synchronized before the program control input PRV is accessed by the instruction code, and a program control output PRV is synchronized after the program control PRV is accessed by the instruction code.

9. A computing device comprising:
one or more processors; and
a non-volatile computer readable medium storing a computer program instructions operable to cause the one or more processors to perform operations comprising:
synchronizing one or more pre-defined real-time variables (PRVs) with a respective one of a one or more of an hardware peripheral and a graphical user interface (GUI) element
receiving an instruction code; and
executing the instruction code.

10. The computing device of claim 9, wherein at least one of the one or more PRVs is an input PRV, such that a value of the at least one input PRV is modified by the respective one of the one or more hardware peripheral and GUI synchronized with the input PRV and accessed by the instruction code.

11. The computing device of claim 9, wherein at least one of the one or more PRVs is an output PRV, such that when a value of the output PRV is modified by the instruction code, the respective one of the one or more hardware peripheral and GUI, synchronized with the output PRV, is automatically updated to the value of said output PRV.

12. The computing device of claim 10, wherein at least one of the one or more PRVs is an output PRV, such that when a value of the output PRV is modified by the instruction code, the respective one of the one or more hardware peripheral and GUI, synchronized with the output PRV, is automatically updated to the value of said output PRV.

13. The computing device of claim 9, wherein the PRVs are synchronized at a predetermined interval.

14. The computing device of claim 9, wherein the PRVs are synchronized as needed, such that a input PRV is synchronized before the input PRV is accessed by the instruction code, and a output PRV is synchronized after the PRV is accessed by the instruction code.

15. A method for developing an industrial instrument, the industrial instrument comprising one or more of an hardware peripheral, method comprising the steps of:
receiving a user program input by a user, the user program including at least one or more pre-defined real-time variables (PRVs) in a program controller;
compiling the user program into a set of instruction code;
reading and executing the instruction code in a sequential manner in the program controller;
accessing by the instruction code the at least one or more PRVs;
transferring the instruction code to the industrial instrument coupled to the program controller;
reading and executing the transferred instruction code sequentially by the industrial instrument; and
synchronizing one or more PRVs in the industrial instrument with the respective hardware peripheral and the at least one or more PRVs in the program controller.

16. The method of claim 15, further comprising
burning the transferred instruction code into a memory at the industrial instrument;
decoupling the industrial instrument from the program controller; and
reading and executing the transferred instruction code sequentially from the memory.

17. The method of claim 16, wherein at least one of the one or more PRVs is an input PRV, the method further comprising:
modifying a value of the at least one input PRV by the respective one of the one or more hardware peripheral synchronized with the input PRV and accessed by the instruction code.

18. The method of claim 16, wherein at least one of the one or more PRVs is an output PRV, the method further comprising
automatically updating the respective one of the one or more hardware peripheral synchronized with the output PRV to a value of the output PRV when the value of the output PRV is modified by the instruction code.

19. The method of claim 16, wherein at least one of the one or more PRVs is an output PRV, the method further comprising
automatically updating the respective one of the one or more hardware peripheral and GUI synchronized with the output PRV to a value of the output PRV when the value of the output PRV is modified by the instruction code.

20. The method of claim 16, wherein the PRVs are synchronized as needed, such that an input PRV is synchronized before the input PRV is accessed by the instruction code, and an output PRV is synchronized after the PRV is accessed by the instruction code.
